(19) United States
(12) Patent Application Publication
(10) Pub. No.: US 2001/0018680 A1
(43) Pub. Date: Aug. 30, 2001

(54) Electronic commerce business settlement system using financial accounts

(76) Inventors: Jun Hyun Park, Seoul (KR); Nak Ho Sung, Ilsan-qu (KR)

Correspondence Address: HARNESS, DICKEY & PIERCE, PLC, 5445 CORPORATE DRIVE, SUITE 400, TROY, MI, 48098, US

(21) Appl. No.: 09/793,942

(22) Filed: Feb. 27, 2001

(30) Foreign Application Priority Data
Feb. 28, 2000 (KR) P2000-9779

(51) Int. Cl. G06F 17/60

(52) U.S. Cl. 705/39

(57) ABSTRACT

A method is disclosed which enables a financial institution server to establish associated relationships with plural electronic commerce business servers, builds data provided from the plural electronic commerce business servers in a database, allows the use of the electronic commerce business by proceeding with the communication connections to the particular electronic commerce servers in case that the corresponding users wish to use the electronic commerce business after the communication connections are performed by the users of the client PCs, and automatically transfers the settlement money to the corresponding electronic commerce business servers if the users select the settlements according to the use of the electronic commerce business as the automatic money transfer at the time with refunding to the corresponding users part of profits incurred according to the electronic commerce business.

### BACKGROUND OF THE INVENTION

1. Field of the Invention

The present invention relates to an electronic commerce business settlement system, and more particularly to an electronic commerce business settlement system using financial accounts, enabling users to use an electronic commerce business when dealing with stocks and banks and to settle costs incurred by the use of the electronic commerce business through his financial accounts on a network, by joining hands with plural electronic commerce business sites at financial institution sides.

2. Description of the Prior Art

In general, the internet is an open-type network constructed for anyone to be able to use through a free connection to a computer of the other side he wants with an application of the common protocol of Transmission Control Protocol/Internet Protocol (TCP/IP), which is used for the transfer of basic text information as well as multimedia information together with compression technology developments, enabling diverse services such as electronic mails, file transfers, World Wide Web (WWW), and so on.

The use of such internet is drastically increased all over the world including the interior, its importance is rapidly increased as a strategic tool for the reconsideration of efficiency and productivity over the entire fields of the existing industry, new business opportunities continue to be created through the internet, and entrepreneurs who use the internet are gradually increasing since it is a tendency that business areas are being expanded.

That is, in recent times, as businesses through the internet, sites which provide a variety of contents, such as internet advertisements, internet broadcasts, online games, internet newspapers/magazines, search services, portal services, electronic commerce businesses, and so on, are abruptly increasing.

From the sites as stated above, electronic commerce business sites in which users of all ranks and classes can purchase various goods such as clothes, books, music discs, and so on are growing as the most spotlighted businesses with the tremendous popularity of the internet users, and it is in a tendency as well that even the portal sites of providing search services, free electronic mails, homepage spaces, cyber folders, and the like are actively introducing the above electronic commerce businesses in order to overcome the limitation of advertisement revenues coming from member recruitments.

At this time, in case that plural users use the above electronic commerce business sites, each user connects to a association with the sites offering the electronic commerce business services.

### SUMMARY OF THE INVENTION

In order to solve the above problem, it is an object of the present invention to provide an electronic commerce business settlement system using financial accounts, enabling plural computer users to use an electronic commerce business when dealing with stocks and banks and to settle costs incurred by the use of the electronic commerce business through his financial accounts on a network, by joining hands with plural electronic commerce business sites at financial institution sides.

Further, it is another object of the present invention to provide an electronic commerce business settlement system using financial accounts, enabling to settle costs incurred by the use of the electronic commerce business through the financial accounts and to receive certain additional services or part of profits from corresponding financial institutions according to the results of use of the electronic commerce business.

In order to achieve the above objects, an electronic commerce business settlement system using financial accounts according to the present invention comprises a communication network for connecting undefined plural communication lines to perform data communications therebetween; plural electronic commerce business servers associated with a particular server of providing financial services, and for providing information of goods contained therein to users who are connected through the particular server, providing settlement methods including an automatic money transfer through financial accounts of the particular server to the users who are willing to purchase particular goods, sending, if settlements of purchased goods are performed according to selections of settlement methods of the corresponding users, the corresponding goods to the users, and providing, if the settlements of the purchased goods are performed according to automatic transfer selections of the corresponding users, part of profits to the particular server; plural client personal computers (PCs) having communication environments able to be connected to the particular server and the electronic commerce business servers opened in the communication network, and for displaying data related to the financial service outputted from the particular server and data related to the plural electronic commerce business servers, proceeding with connections to particular electronic commerce business servers selected by users who have confirmed the data of the electronic commerce business server which is outputted from the particular server, displaying information of plural goods outputted from corresponding electronic commerce business servers at the same time with outputting to the corresponding electronic commerce business servers electronic commerce business settlement data for goods the user wishes to purchase; and a financial institution server associated with the plural electronic commerce business servers including the automatic transfer in the electronic commerce business settlement methods, and for outputting to corresponding client PCs financial service data built in a database according to the communication connections of the users of the plural client PCs and data of the plural electronic commerce business servers, automatically transferring settlement money, if corresponding users of the client PCs select the automatic transfer as a settlement method of costs incurred when purchasing particular goods after proceeding with connections to particular electronic commerce business servers, from accounts of the corresponding users to accounts of the particular electronic commerce business servers according to requests of the particular electronic commerce business servers, classifying by the corresponding users and storing profits provided from the particular electronic commerce business servers according to the automatic transfer settlements of the users of the client PCs at the same time refunding part of the profits to the corresponding users.

An electronic commerce business settlement method using financial accounts according to the present invention comprises steps of (1) establishing associated relationships with plural electronic commerce business servers at a financial institution server and building in a database data provided from the associated plural electronic commerce business servers; (2) performing communication connections to the financial institution server by the users of the client PCs; (3) proceeding with a communication connection to a particular electronic commerce business server selected by a user of a client PC who wishes to use the electronic commerce business at the financial institution server and executing the settlement of costs according to the use of the electronic commerce business by a selection of an automatic transfer settlement means by the corresponding user of the client PC; and (4) receiving from the particular electronic commerce business server profits incurred according to the electronic commerce business through the automatic transfer settlement means of the corresponding user of the client PC, and refunding to the corresponding user the profits provided from the particular electronic commerce server.

### BRIEF DESCRIPTION OF THE DRAWINGS

The above objects and other advantages of the present invention will become more apparent by describing in detail a preferred embodiment thereof with reference to the attached drawings, in which:

FIG. 1 is a block diagram for schematically showing a structure of an electronic commerce business settlement system using financial accounts according to an embodiment of the present invention;

FIG. 2 is a block diagram for showing in detail a financial institution server of FIG. 1;

FIG. 3 is a flow chart for showing process steps of an electronic commerce business settlement method using financial accounts according to an embodiment of the present invention; and

FIG. 4 to FIG. 7 are flow charts for showing in detail process steps of each subroutine of FIG. 3.

### DETAILED DESCRIPTION OF THE PREFERRED EMBODIMENT

Hereinafter, an electronic commerce business settlement system using financial accounts according to an embodiment of the present invention will be described with reference to the accompanying drawings.

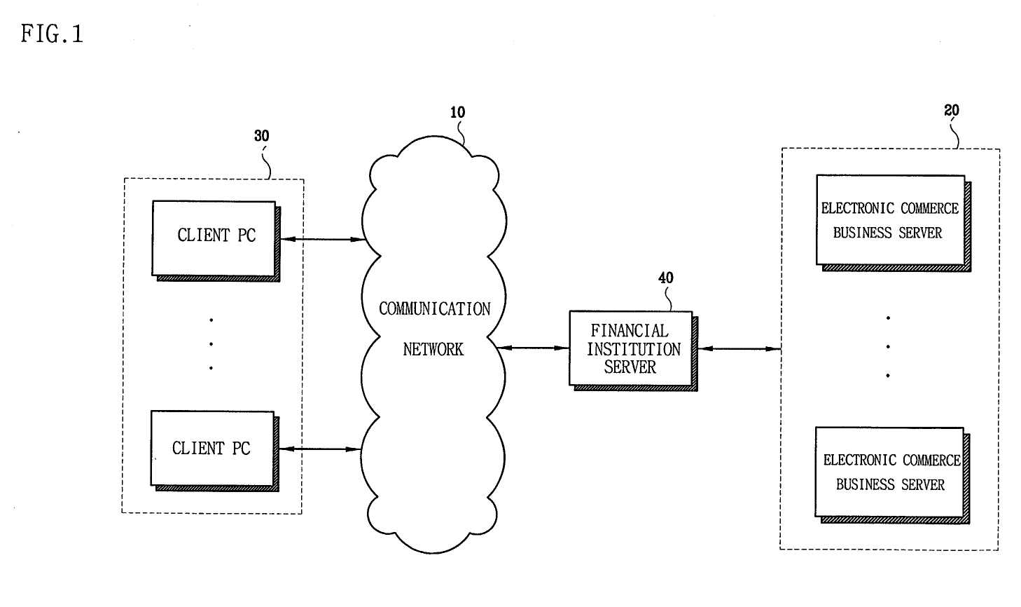

FIG. 1 is a block diagram for schematically showing a structure of an electronic commerce business settlement system using financial accounts according to an embodiment of the present invention.

As shown in FIG. 1, a communication network 10 is a communication network such as the internet and the like, which connects communication lines between plural client personal computers (PCs) 30 and a financial institution server 40, described later, to perform communications of data related to financial services therebetween.

Further, the communication network 10 connects communication lines between the plural client PCs 30 and plural electronic commerce business servers 20 through the financial institution server 40, described later, to perform communications of data related to an electronic commerce business.

The plural electronic commerce servers 20 are joined with the financial institution server 40, described later, for offering financial services to provide information on plural goods they have to the users of the client PCs 30 connected through the financial institution server 40, and, provide settlement methods including an automatic transfer through a financial account of the financial institution server 40 to users, after confirming the information of the plural goods, who wish to purchase particular goods.

Further, the plural electronic commerce business servers 20, if settlements of purchased goods are performed according to corresponding client PCs users' choices of settlement methods, send the corresponding goods to the users, and provide part of profits to the financial institution server 40 in case that the settlements of the purchased goods are performed according to corresponding users' selections of the automatic transfers. At this time, each of the above electronic commerce business servers 20 should have the financial accounts of the financial institution server 40 in association with it.

The plural client PCs 30 have communication environments for the client PCs 30 to be connected to the financial institution server 40 and the plural electronic commerce business servers 20, described later, and receive data related to financial services outputted from the financial institution server 40 and data related to the plural electronic commerce business servers 20 for display on screens.

Further, the plural client PCs 30 proceed with communication connections to particular electronic commerce business servers 20 selected by users who have confirmed data of the plural electronic commerce business servers 20 outputted from the financial institution server 40, display information on plural goods outputted from corresponding electronic commerce business servers 20, and output electronic commerce business settlement data of goods which users wish to purchase to corresponding electronic commerce business servers 20.

The financial institution server 40 establishes associated or hands-joined relations with the plural electronic commerce business servers 20 which have electronic commerce business settlement methods including the automatic transfer, and outputs to corresponding client PCs 30 financial service data built as a database and data of the plural electronic commerce business servers 20 according to communication connections of the users of the plural client PCs 30.

Further, the financial institution server 40, if the users of corresponding client PCs 30 select the automatic transfer as a settlement method for the costs incurred upon the purchase of particular goods after performing connections to the particular electronic commerce business servers 20, automatically transfers settlement payments to accounts of particular electronic commerce business servers 20 from the accounts of corresponding users according to the requests of the particular electronic commerce business servers 20, classifies by the corresponding users and stores profits provided from the particular electronic commerce business servers 20 according to the automatic transfer settlements of the users of the client PCs 30, and refunds part of the profits to the corresponding users.

At this time, in addition to the refund of the profits incurred according to the result of the uses of the electronic commerce business as the users of the corresponding client PCs 30 select the settlement method as the automatic transfer, the above financial institution server 40 can be operated to provide pay information corresponding to the profits to the users of corresponding client PCs 30.

Further, the financial institution server 40, in case that a user registered as a member performs a connection and performs a connection to a particular electronic commerce business server 20 associated with the financial institution server 40, allows the user to directly connect to the corresponding electronic commerce server 20 without user authentication steps such as inputs of ID and password, and so on.

Further, the financial institution server 40 has an electronic commerce button (not shown) on a main screen on the web for allowing the use of the electronic commerce business services, provides the user of the corresponding client PC 30 with a window including a list of the joined plural electronic commerce business server 20 built in a database if the electronic commerce business button is selected for using the electronic commerce business while the user of the communication-connected client PC 30 uses financial services, and controls to be communication-connected to a corresponding electronic commerce business server 20 if the user selects the desired electronic commerce business server 20.

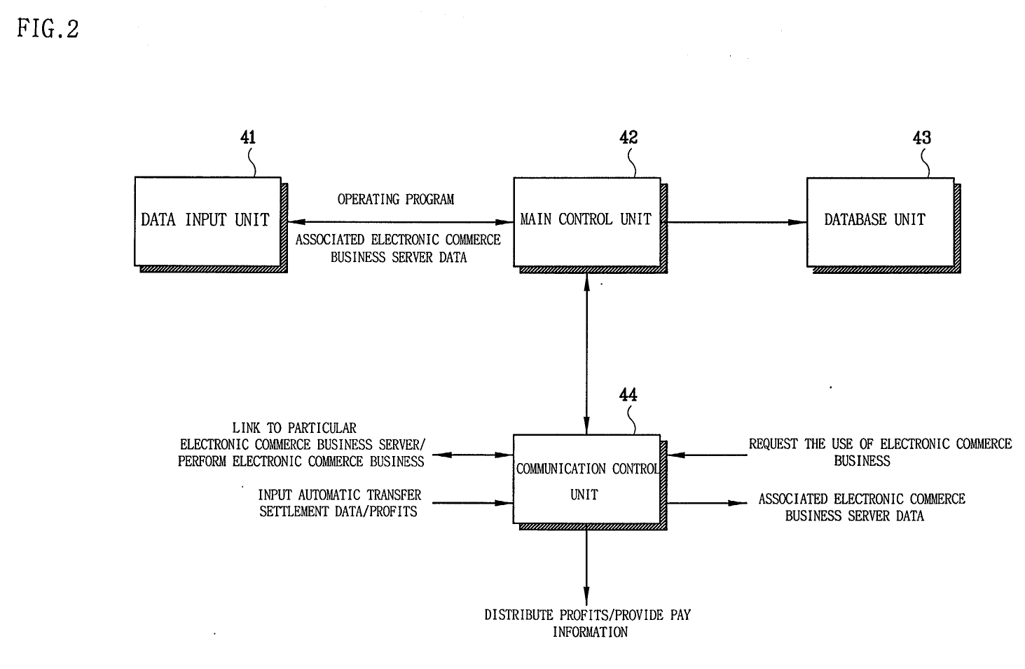

FIG. 2 is a block diagram for showing in detail a financial institution server 20 of FIG. 1.

As shown in FIG. 2, a data input unit 41 inputs and outputs to a main control unit 42 data related to plural electronic commerce business server 20 in hands-joined relations with the financial institution server 40, including an operating program and the automatic transfer as an electronic commerce business settlement method supported for users of the plural client PCs 30 to receive the financial services and electronic commerce business services.

The main control unit 42 controls to store in a database unit 43 described later data related to the plural electronic commerce business servers 20 inputted through the data input unit 41 and member registration data of the users of the plural client PCs 30, and controls communication connections with corresponding commerce business servers 20 if requests for electronic commerce business uses are performed by the users of the client PCs 30 who use various financial services such as banks, stocks, and the like.

Further, the main control unit 42, in case that the users of the client PCs 30 who confirms information of plural goods provided in corresponding electronic commerce business servers 20 select the automatic transfer as a settlement method of their purchased goods, controls to automatically transfer settlement payments from the accounts of the corresponding users to the accounts of particular electronic commerce business servers 30 according to the requests of the corresponding electronic commerce business servers 20, controls to receive from the electronic commerce business servers 20 and store by the users certain amounts of profits incurred according to the uses of the electronic commerce business through the automatic transfer of the users of the corresponding client PCs 30, and controls to refund part of the profits to the corresponding users.

The database unit 43 stores a variety of data such as publicity materials and the like related to the plural electronic commerce business servers 20 which are inputted through the data input unit 41 according to the control of the main control unit 42, stores member registration data inputted by the users of the client PCs 30, and accumulates and stores the electronic commerce business result data through the automatic transfer of each user of the client PCs 30.

A communication control unit 44 receives and outputs to the main control unit 42 the member registration data or request signals for the use of the electronic commerce business inputted by corresponding users during the communication connections of the client PCs 30, and links the corresponding users of the client PCs 30 to particular electronic commerce business servers 20 according to the controls of the main control unit 42.

Further, the communication control unit 44 inputs and outputs to the main control units 42 automatic transfer request signals from particular electronic commerce business servers 20 according to the settlement selections of the automatic transfers with respect to the use of the electronic commerce business by the corresponding users of the client PCs 30, and outputs to the corresponding client PCs 30 the use results of electronic commerce business according to the automatic transfer settlements used by the corresponding users of the client PCs 30 outputted from the main control unit 42.

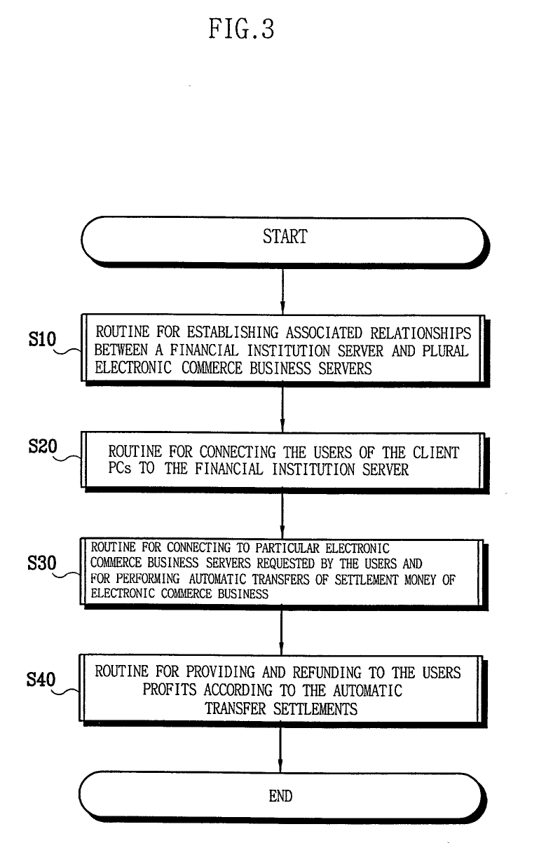

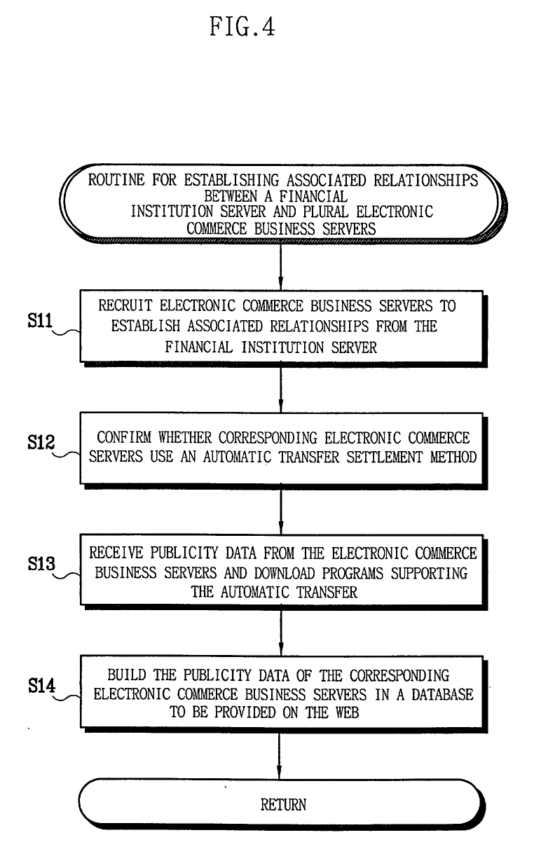

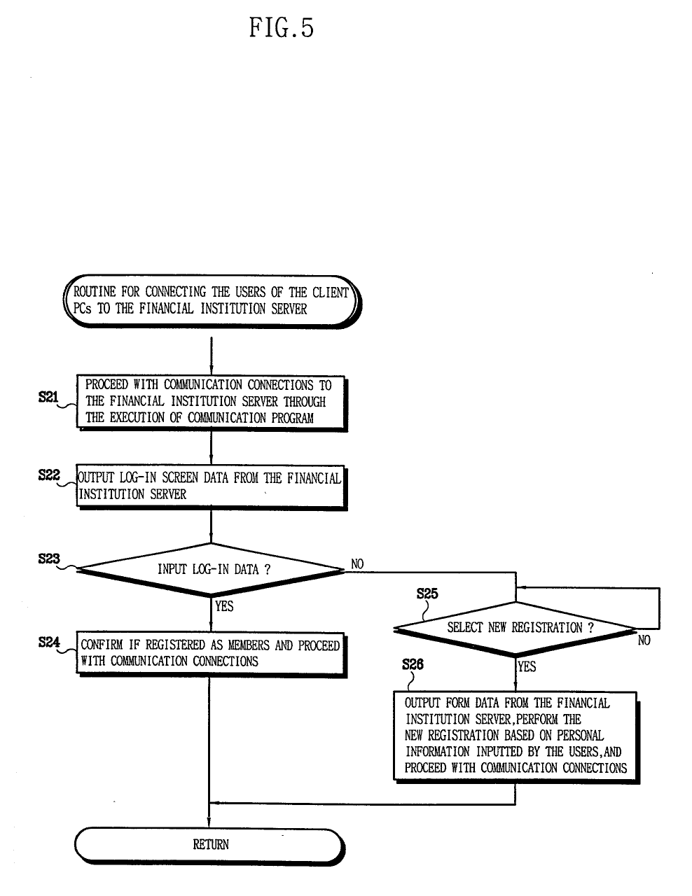

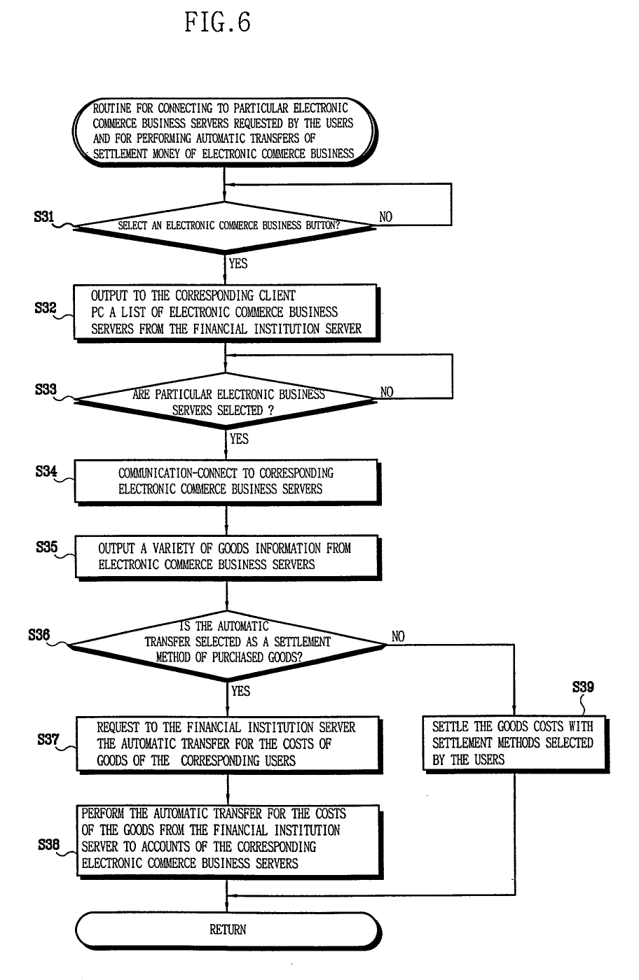

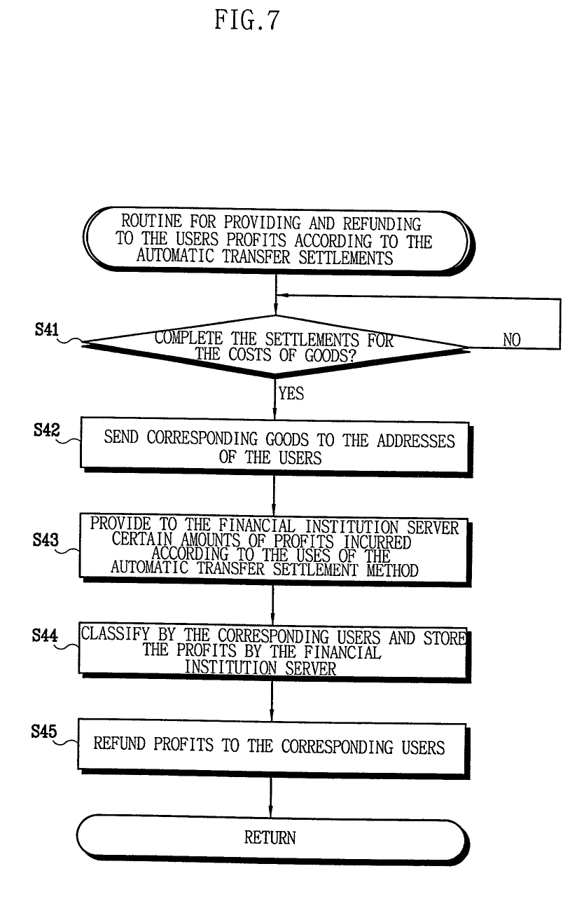

Next, an electronic commerce business settlement method using financial accounts according to an embodiment of the present invention having the above structure is described in detail with reference to FIG. 3 to FIG. 7.

FIG. 3 to FIG. 7 are flow charts for showing process steps of an electronic commerce business settlement method using financial accounts according to an embodiment of the present invention.

First, the financial institution server 40 which provides various financial services such as bank, stocks, and the like establishes hands-joined or associated relations with the plural electronic commerce business servers 20 in order to provide electronic commerce business services having a settlement method of an automatic money transfer, in addition to credit cards and deposits without passbooks of the existing settlement methods, to customers who use the communication network 10, and builds a database with data provided from the hands-joined plural electronic commerce business servers 20 (S10).

That is, the financial institution server 40 recruits electronic commerce business servers 20 to be in hands-joined relations (S11), and confirms that corresponding electronic commerce business servers 20 in response to the hands-joined relationship establishment include the automatic transfer settlement method using the accounts of the corresponding financial institution (S12).

Thereafter, the financial institution server 40 inputs site publicity data related to goods sales information, prices information, and so on, from the corresponding electronic commerce business servers 20 which has been confirmed to include the automatic transfer as a new settlement method, and downloads a program which supports the automatic transfer settlement method to the corresponding electronic commerce business servers 20 (S13).

Further, the financial institution server 40 builds the publicity data provided from the corresponding electronic commerce business servers 20 as a database and provides the database to be viewed by all the users (S14).

From now on, in order for the users of the client PCs 30 to use the electronic commerce business with the new settlement method of the automatic transfer through the above step S10, after the financial institution server 40 establishes the hands-joined relationship with the plural electronic commerce business servers 20, the financial institution server 40 confirms that the users of the plural client PCs 30 can performs communication connections with the financial institution server 40 through the communication network 10 (S20)

That is, if the users of the client PCs 30 having financial accounts of corresponding financial institutions execute communication programs to perform communication connections with the financial institution server 40 (S21), the financial institution server 40 outputs data for a user log-in screen to the corresponding client PCs 30 which have tried the communication connections (S22).

Further, it is judged that the users of the corresponding client PCs 30 input the log-in data of IDs and passwords according to the log-in screen data outputted from the financial institution server 40 (S23), and the financial institution server 40 confirms whether the users are registered members through the log-in data inputted by the users of the corresponding client PCs 30, and proceeds with the communication connections in case that the users are regular registration members (S24)

However, if the log-in data is not inputted as a result of the judgement in the above step S23, the financial institution server 40 judges if the corresponding users of the client PCs 30 select new registrations included in the log-in screen data (S25), and, if the users select the new registrations, the financial institution server 40 outputs certain form data necessary for the new registrations to the corresponding client PCs 30, performs the new member registrations based on the personal information including the financial account data the corresponding users input and then proceeds with the communication connections (S26).

After the users of the plural client PCs 30 perform the communication connections with the financial institution server 40 through the above step S20, the financial institution server 40, in case that the corresponding users of the client PCs 30 use the electronic commerce business during the uses of the financial services, proceeds with the communication connections with particular electronic commerce business servers 20 the users select, and performs the settlements of the costs according to the use of the electronic commerce business according to the selections of the users' automatic transfer settlement method (S30).

That is, the financial institution server 40 judges if the users of the client PCs 30 select the electronic commerce business button during the use of the financial service provided by the financial institution server 40 (S31), and, if the corresponding users of the client PCs 30 select the electronic commerce business button, the financial institution server 40 outputs to the corresponding client PCs 30 a list of all the electronic commerce business server 20 in the hands-joined relationship which are built in a database (S32).

Further, the financial institution server 40 judges if the users of the client PCs 30 which have confirmed the list of the electronic commerce business servers 20 select particular electronic commerce business servers 20 out of the electronic commerce business servers 20 which have goods information the users wish to purchase (S33), and, if the particular electronic commerce business servers 20 are selected by the users of the client PCs 30, performs the communication connections with the particular electronic commerce business servers 20 the corresponding users select (S34).

At this time, in case that the financial institution server 40 proceeds with the communication connections with the particular electronic commerce business servers 20 selected by the users in the above step S34, the financial institution server 40 outputs the log-in data inputted when the corresponding users of the client PCs 30 performs the member registrations to automatically execute the user authentications, so that the users of the client PCs 30 can use the corresponding electronic commerce servers 20 without the performances of separate user authentication steps.

As stated above, if the connections to the particular electronic commerce business servers 20 are performed through the financial institution server 40, the corresponding electronic commerce business servers 20 output to corresponding client PCs 30 the information of plural goods they have (S35).

Further, if goods to be purchased are selected by the users of the client PCs 30 which have confirmed the information of plural goods provided from the electronic commerce business servers 20, the electronic commerce business servers 20 judges if the corresponding users select the automatic transfer as a settlement method for the costs of the goods (S36).

If the users of the client PCs 30 select the automatic transfer as the settlement method for the costs of the goods as a result of the judgement in the step S36, the electronic commerce business servers 20 request the information of the corresponding users and the automatic transfer for the costs of the goods to the financial institution server 40 (S37).

Further, if the requests of the automatic transfer for the costs of the goods is received at the financial institution server 40 by the particular electronic commerce business servers 20 according to the electronic commerce business of the users of the client PCs 30, the financial institution server 40 confirms the dealings contents of the electronic commerce business and performs the automatic transfer for the costs of the goods according to the use of the electronic commerce business to the corresponding accounts of the electronic commerce business servers (S38).

However, if the automatic transfer is not selected as the settlement method for the costs of the goods as a result of the judgement in the step S36, if the automatic transfer is not selected as a settlement method for the costs of the goods as a result of the judgement in the above step S36, the corresponding electronic commerce business servers 20 settle the costs of the goods with settlement methods such as credit cards and so on the users of the client PCs 30 select.

Lastly, the financial institution server 40 receives from the particular electronic commerce business servers 20 certain amounts of profits incurred according to the electronic commerce business through the automatic transfer settlement method of the corresponding users of the client PCs 30, and refunds the profits provided from the particular electronic commerce business server 20 to the corresponding users (S40).

That is, the corresponding electronic commerce business server 20 judges if the settlement for the costs of the goods of the users of the client PCs 30 are completed S41, sends the corresponding goods to the addresses of the users if the settlements of the goods costs are completed (S42), and provides to the financial institution server 40 certain amounts of profits incurred according to the electronic commerce business through the automatic transfer settlement method (S43).

At this time, certain amounts of profits incurred according to the electronic commerce business preferably become the amounts equivalent to fees to be provided to credit card companies from the electronic commerce business servers 20 in case of the use of credit cards, and, in addition, the amounts of the profits can be adjusted through separate contracts with the financial institution server 40.

Thereafter, the financial institution server 40 stores data by classifying the certain amounts of profits from the electronic commerce business servers 20 by the corresponding users (S44), and refunds the profits incurred according to the use of the automatic transfer settlement method to the corresponding users of the client PCs 30 (S45).

Of course, the financial institution server 40 can provide a variety of pay information corresponding to the profits to the corresponding users of the client PCs 30, in addition to the method for refunding part of the profits to the users, as stated above.

As described above, with an electronic commerce business settlement system using financial accounts according to the present invention, by settling the costs of goods according to the use of the electronic commerce business through the automatic transfer using the accounts of the financial institutions of providing a diversity of financial services related to banks and stocks, the financial institutions can increase customers' satisfaction degrees by offering various services, obtain long-term customer recruitments by giving the functions of the

What is claimed is:

1. An electronic commerce business settlement system using financial accounts, comprising:
a communication network for connecting plural communication lines to perform data communications therebetween;
plural electronic commerce business servers associated with a particular server providing financial services, and for providing information of goods contained therein to users who are connected through the particular server, providing settlement methods including an automatic money transfer through financial accounts of the particular server to the users who are willing to purchase particular goods, sending, if settlements of purchased goods are performed according to selections of settlement methods of the corresponding users, the corresponding goods to the users, and providing, if the settlements of the purchased goods are performed according to automatic transfer selections of the corresponding users, part of profits to the particular server;
plural client personal computers (PCs) having communication environments able to be connected to the particular server and the electronic commerce business servers opened in the communication network, and for displaying data related to the financial service outputted from the particular server and data related to the plural electronic commerce business servers, proceeding with connections to particular electronic commerce business servers selected by users who have confirmed the data of the electronic commerce business server which is outputted from the particular server, displaying information of plural goods outputted from corresponding electronic commerce business servers at the same time with outputting to the corresponding electronic commerce business servers electronic commerce business settlement data for goods the user wishes to purchase; and
a financial institution server associated with the plural electronic commerce business servers including the automatic transfer in the electronic commerce business settlement methods, and for outputting to corresponding client PCs financial service data built in a database according to the communication connections of the users of the plural client PCs and data of the plural electronic commerce business servers, automatically transferring settlement money, if corresponding users of the client PCs select the automatic transfer as a settlement method of costs incurred when purchasing particular goods after proceeding with connections to particular electronic commerce business servers, from accounts of the corresponding users to accounts of the particular electronic commerce business servers according to requests of the particular electronic commerce business servers, classifying by the corresponding users and storing profits provided from the particular electronic commerce business servers according to the automatic transfer settlements of the users of the client PCs at the same time refunding part of the profits to the corresponding users.

2. The system as claimed in claim 1, wherein the financial institution server includes:
a data input unit including operation programs supported by server administrators in order for the users of the client PCs to be provided with financial services and the electronic commerce business services and the automatic transfer as a settlement method of the electronic commerce business, and for inputting data related to the plural electronic commerce business servers having associated relationships with the financial institution server;
a main control unit for controlling the storage of the data related to the electronic commerce business servers and member registration data of the users of the plural client PCs which are inputted through the data input unit, controlling connections to electronic commerce business servers according to requests of the use of the electronic commerce business of the users of the client PCs, controlling, if the users of the client PCs who have confirmed information of plural goods provided from corresponding electronic commerce business servers select the automatic transfer as a settlement method of the goods to be purchased, to automatically transfer settlement money from accounts of the corresponding users to accounts of particular electronic commerce business servers according to the requests of the electronic commerce business servers, and controlling to store by the corresponding users by receiving from the electronic commerce business servers certain amounts of profits incurred according to the use of electronic commerce business through the automatic transfer of the users of the corresponding client PCs at the same time with controlling to refund part of profits to the corresponding users;
a database unit for storing the data related to the plural electronic commerce business servers inputted through the data input unit according to the control of the main control unit, storing member registration data the users of the client PCs input, and accumulating and storing electronic commerce business result data through the automatic transfer of each user of the client PCs; and
a communication control unit for inputting and outputting to the main control unit the member registration data and request signals for the use of the electronic commerce business which the corresponding users input according to the communication connections of the client PCs, linking the corresponding users of the client PCs to the particular electronic commerce business servers according to the control of the main control unit, inputting and outputting to the main control unit automatic transfer request signals from the particular electronic commerce business servers according to the selections of the automatic transfer settlements according to the use of the electronic commerce business of the corresponding users of the client PCs, and outputting to the corresponding client PCs the results of the use of the electronic commerce business according to the automatic transfer settlements used by the corresponding users of the client PCs which are outputted from the main control unit.

3. The system as claimed in claim 1, wherein the financial institution server provides to the corresponding users of the client PCs pay information equivalent to the profits incurred according to the results of the use of the electronic commerce business with a settlement method of the automatic transfer by the corresponding users of the client PCs.

4. The system as claimed in claim 1, wherein the financial institution server, in case that users registered as members perform connections with the particular electronic commerce business servers associated with the financial institution server after having performed connections, are enabled to be directly connected to the corresponding electronic commerce servers without separate user authentication steps.

5. The system as claimed in claim 1, wherein the financial institution server has an electronic commerce business button for allowing the use of the electronic commerce business services on a primary screen on the communication network, provide, if the users of the communication-connected client PCs select the electronic commerce business button in order to use the electronic commerce business during the use of the financial services, to the corresponding users of the client PCs a window which includes a list of the associated plural electronic commerce business server built in a database, and, if the user selects a desired electronic commerce business server, communication-connects to the corresponding electronic commerce business server.

6. An electronic commerce business settlement method using financial accounts, comprising steps of:
(1) establishing associated relationships with plural electronic commerce business servers at a financial institution server and building in a database data provided from the associated plural electronic commerce business servers;
(2) performing communication connections to the financial institution server by users of client PCs;
(3) proceeding with a communication connection to a particular electronic commerce business server selected by a user of a client PC who wishes to use the electronic commerce business at the financial institution server and executing the settlement of costs according to the use of the electronic commerce business by a selection of an automatic transfer settlement means by the corresponding user of the client PC; and
(4) receiving from the particular electronic commerce business server profits incurred according to the electronic commerce business through the automatic transfer settlement means of the corresponding user of the client PC, and refunding to the corresponding user the profits provided from the particular electronic commerce server.

7. The method as claimed in claim 6, wherein the step (1) includes steps of:
(1-1) recruiting the electronic commerce business servers to establish the associated relationships at the financial institution server;
(1-2) confirming if the corresponding commerce business servers in response to the associated relationship establishment include the automatic transfer settlement means using accounts of the corresponding financial institution in the electronic commerce business settlement means;
(1-3) inputting site publicity data from the corresponding electronic commerce business servers promised to provide the automatic transfer settlement means, and downloading to the corresponding electronic commerce business servers programs supporting the automatic transfer settlement means; and
(1-4) building in the database the publicity data provided from the corresponding electronic commerce business servers and providing the same on a web.

8. The method as claimed in claim 6, wherein the step (2) includes steps of:
(2-1) performing the communication connections to the financial institution server by executing the communication program by the users of the client PCs;
(2-2) outputting user log-in screen data to a corresponding client PC from the financial institution server if the communication connections are performed;
(2-3) judging if the corresponding users of the client PCs input log-in data of IDs and passwords through the log-in screen;
(2-4) confirming by the financial institution server whether or not the users are registered members through the log-in data inputted by the users and proceeding with the communication connections;
(2-5) judging whether the corresponding users of the client PCs select new registrations included in the log-in screen data if the log-in data is not inputted as a result of the judgement of the step (2-3); and
(2-6) outputting to the corresponding client PCs predetermined form data necessary for the new registration from the financial institution server if the users select the new registration, and proceeding with the communication connection after performing the new member registrations based on personal information including financial account data inputted by the corresponding users.

9. The method as claimed in claim 6, wherein the step (3) includes steps of:
(3-1) judging if the electronic commerce business button is selected during the use of the financial services provided from the financial institution server by the users of the client PCs;
(3-2) outputting to the corresponding client PCs a list of the associated electronic commerce business servers built in the database in the financial institution server;
(3-3) judging if the users of the client PCs who have confirmed the electronic commerce business server list select the particular electronic commerce business server;
(3-4) performing the communication connections with the particular electronic commerce business servers selected by the corresponding users at the financial institution server if the particular electronic commerce business server is selected by the users of the client PCs;
(3-5) outputting to the corresponding client PCs information of plural goods the electronic commerce business servers have;
(3-6) judging whether the automatic transfer is selected as a settlement means of the costs of the goods after goods to be purchased out of the information of the plural goods are selected by the corresponding users of the client PCs;
(3-7) requesting the automatic transfer of the costs of the goods of the corresponding users from the corresponding electronic commerce business server to the financial institution server if the users of the client PCs select the automatic transfer as the settlement means of the costs of the goods;
(3-8) performing the automatic transfer of the costs of the goods according to the uses of the electronic commerce business from the accounts of the users to the corresponding accounts of the electronic commerce business servers by the financial institution server if the automatic transfer requests are received by the financial institution server by the particular electronic commerce business server; and
(3-9) settling the costs of the goods through a settlement means selected by the users of the client PCs from the corresponding electronic commerce business servers if the automatic transfer is not selected as the settlement means of the costs of the goods as a result of the judgement of the step (3-6).

10. The method as claimed in claim 9, wherein, in case that the financial institution server proceeds with communication connections to the particular electronic commerce business servers selected by the users in the step (3-4), the financial institution server automatically performs user authentications by outputting the log-in data inputted upon executing the member registrations by the corresponding users of the client PCs from the financial institution server.

11. The method as claimed in claim 6, wherein the step (4) includes steps of:
(4-1) judging if the corresponding electronic commerce servers complete the settlements for the costs of the goods of the users of the client PCs;
(4-2) sending the corresponding goods to the addresses of the users if the settlements of the costs of the goods are completed;
(4-3) providing certain amounts of the profits to the financial institution server in case that the corresponding electronic commerce business servers use the automatic transfer as the settlement means;
(4-4) classifying by the corresponding users and storing data by the financial institution server provided with the certain amounts of profits from the electronic commerce business servers; and
(4-5) refunding the profits incurred according to the use of the automatic transfer settlement means to the corresponding users of the client PCs from the financial institution server.
